(19) United States
(12) Patent Application Publication
(10) Pub. No.: US 2017/0263124 A1
(43) Pub. Date: Sep. 14, 2017

(54) AUXILIARY PARKING METHOD AND SYSTEM, AND NAVIGATION METHOD

(71) Applicant: BOE TECHNOLOGY GROUP CO., LTD., BEIJING (CN)

(72) Inventor: Wenbo LI, Beijing (CN)

(21) Appl. No.: 15/209,990

(22) Filed: Jul. 14, 2016

(30) Foreign Application Priority Data
Mar. 8, 2016 (CN) 201610131594.9

(51) Int. Cl. G08G 1/14; G08G 1/0968

(52) U.S. Cl. CPC G08G 1/143; G08G 1/0968

(57) ABSTRACT

The present invention provides an auxiliary parking method, comprising: acquiring identity information of a vehicle to be parked, the identity information including information of a navigation terminal corresponding to the vehicle; acquiring status information of each parking space in a parking lot, the status information including information indicating whether the parking space is occupied or not; when there is an unoccupied parking space in the parking lot, assigning a target parking space from all of the unoccupied parking space(s) to the vehicle to be parked; and sending information including a map of the parking lot and a location of the target parking space in the parking lot to the navigation terminal corresponding to the vehicle to be parked. Correspondingly, the present invention also provides an auxiliary parking system, a navigation method and a navigation terminal.

### CROSS-REFERENCE TO RELATED APPLICATION

This application claims priority to Chinese Patent Application No. 201610131594.9, filed on Mar. 8, 2016, the contents of which are incorporated by reference in the entirety.

### TECHNICAL FIELD

The present invention relates to the field of intelligent parking lot management, and particularly relates to an auxiliary parking method, an auxiliary parking system, a navigation method and a navigation terminal, which are applied in a parking lot.

### BACKGROUND

In an existing parking lot, especially in an underground parking lot, garages occupy a large area and are even distributed in multiple floors, therefore, a parking space needs to be found in a large range when a vehicle enters the parking lot for parking. In addition, management staffs of the parking lot need to set up a barrier or a sign on site for guiding parking, which wastes time, easily causes traffic jam, and brings about great security risk. On the other hand, when a driver returns back to the parking lot to pick up his vehicle, it usually takes a long time to find the vehicle.

### SUMMARY

An object of the present invention is to provide an auxiliary parking method, an auxiliary parking system, a navigation method and a navigation terminal, which are applied in a parking lot to allow a required parking space to be found fast and accurately while parking and picking up a vehicle.

According to one aspect of the present invention, there is provided an auxiliary parking method, comprising steps of: acquiring identity information of a vehicle to be parked, the identity information including information of a navigation terminal corresponding to the vehicle; acquiring status information of each parking space in a parking lot, the status information including information indicating whether the parking space is occupied or not; when there is an unoccupied parking space in the parking lot, assigning a target parking space from all of the unoccupied parking space(s) to the vehicle to be parked; and sending information including a map of the parking lot and a location of the target parking space in the parking lot to the navigation terminal corresponding to the vehicle to be parked.

According to embodiments of the present invention, the step of assigning a target parking space from all of the unoccupied parking space(s) to the vehicle to be parked may comprise: acquiring an initial position of the vehicle to be parked; acquiring a route from the initial position to each unoccupied parking space and/or vehicle density on the route from the initial position to each unoccupied parking space; and assigning the unoccupied parking space that the vehicle to be parked can reach in the shortest time as the target parking space according to the route from the initial position to each unoccupied parking space and/or the vehicle density on the route from the initial position to each unoccupied parking space.

According to the embodiments of the present invention, the identity information may further include a license plate number.

According to the embodiments of the present invention, the auxiliary parking method may further comprise a step of: storing the status information of each parking space and corresponding relation between the license plate number of the vehicle to be parked and the target parking space.

According to the embodiments of the present invention, the auxiliary parking method may further comprise steps of: acquiring position information including a current position of the navigation terminal in real time; acquiring status information of each parking space positioned between the current position of the navigation terminal and the corresponding target parking space; and when there is an unassigned unoccupied parking space positioned between the current position of the navigation terminal and the corresponding target parking space, assigning the unoccupied parking space closest to the current position of the navigation terminal as a new target parking space, and sending position information of the new target parking space to the navigation terminal.

According to the embodiments of the present invention, the auxiliary parking method may further comprise a step of: acquiring an instruction from a user of the navigation terminal, the instruction indicating whether to accept the new target parking space; and when the new target parking space is accepted, updating the stored corresponding relation between the license plate number of the vehicle to be parked and the target parking space.

According to the embodiments of the present invention, the step of acquiring position information including a current position of the navigation terminal in real time may comprise steps of: transmitting position signals from a plurality of positions in the parking lot; acquiring, in real time, strengths of the position signals received by the navigation terminal from each of the positions; and calculating relative position relations between the navigation terminal and the plurality of positions according to the strengths of each of the position signals received by the navigation terminal, so as to acquire the current position of the navigation terminal in the parking lot.

According to the embodiments of the present invention, the auxiliary parking method may further comprise a step of: sending the position information including the current position of the navigation terminal to the navigation terminal.

According to the embodiments of the present invention, the auxiliary parking method may further comprise steps of: detecting, for each parking space, whether a vehicle enters or leaves the parking space; when a vehicle enters the parking space, acquiring a license plate number of the vehicle entering the parking space, judging whether the license plate number of the vehicle entering the parking space matches the parking space according to the stored corresponding relation between the license plate number of the vehicle to be parked and the target parking space, updating the status information of the parking space if the license plate number of the vehicle entering the parking space matches the parking space, otherwise, generating an alarm signal; and when a vehicle leaves the parking space, updating the status information of the parking space.

According to another aspect of the present invention, there is provided a navigation method, comprising steps of: acquiring information including a map of a parking lot and a location of a target parking space in the parking lot according to the auxiliary parking method provided by the present invention, and storing the location of the target parking space in the parking lot; acquiring position information including a current position in real time; and acquiring a route from the current position to a target position according to the current position, the target position and the map of the parking lot, wherein the target position includes the location of the target parking space in the parking lot or a location of an exit of the parking lot in the parking lot.

According to the embodiments of the present invention, the step of acquiring a route from the current position to a target position may comprise steps of: acquiring each of routes from the current position to the target position and vehicle density on each of the routes from the current position to the target position; and calculating a route along which the target position can be reached in the shortest time according to each of the routes from the current position to the target position and the vehicle density on each of the routes from the current position to the target position. The vehicle density on each of the routes may be compared with a preset value, and the shortest route among all of the routes on which the vehicle densities are smaller than the preset value is determined as the route along which the target position can be reached in the shortest time.

According to the embodiments of the present invention, the navigation method may further comprise steps of: when the target position includes the location of the target parking space in the parking lot and there is an unoccupied parking space positioned between the current position and the target parking space, acquiring an instruction from a driver, the instruction indicating whether to accept the unoccupied parking space as a new target parking space; when the new target parking space is accepted, updating a route from the current position to the target parking space according to the new target parking space, and updating the stored location of the target parking space in the parking lot; and sending out the instruction of the driver.

According to the embodiments of the present invention, the step of acquiring position information including a current position in real time may comprise steps of: receiving position signals transmitted from a plurality of positions in the parking lot; sending out strengths of the position signals received from the plurality of positions; and receiving the position information including the current position in the parking lot determined based on the strengths of the position signals.

According to another aspect of the present invention, there is provided an auxiliary parking system, comprising a vehicle information acquisition module configured to acquire identity information of a vehicle to be parked, the identity information including information of a navigation terminal corresponding to the vehicle; a parking space information acquisition module configured to acquire status information of each parking space in a parking lot, the status information including information indicating whether the parking space is occupied or not; a first parking space assignment module configured to assign a target parking space from all unoccupied parking space(s) to the vehicle to be parked when there is (are) the unoccupied parking space(s) in the parking lot; and a parking space information sending module configured to send information including a map of the parking lot and a location of the target parking space in the parking lot to the navigation terminal corresponding to the vehicle to be parked.

According to embodiments of the present invention, the first parking space assignment module may comprise an initial position acquisition unit configured to acquire an initial position of the vehicle to be parked; a route information acquisition unit configured to acquire a route from the initial position to each unoccupied parking space and/or vehicle density on the route from the initial position to each unoccupied parking space; and a parking space selection unit configured to assign the unoccupied parking space that the vehicle to be parked can reach in the shortest time as the target parking space according to the route from the initial position to each unoccupied parking space and/or the vehicle density on the route from the initial position to each unoccupied parking space.

According to the embodiments of the present invention, the identity information may further include a license plate number.

According to the embodiments of the present invention, the auxiliary parking system may further comprise a storage module configured to store the status information of each parking space and corresponding relation between the license plate number of the vehicle to be parked and the target parking space.

According to the embodiments of the present invention, the auxiliary parking system may further comprise a terminal position acquisition module and a second parking space assignment module. The terminal position acquisition module is configured to acquire position information including a current position of the navigation terminal in real time, the parking space information acquisition module acquires status information of each parking space positioned between the current position of the navigation terminal and the corresponding target parking space, and when there is an unassigned unoccupied parking space positioned between the current position of the navigation terminal and the corresponding target parking space, the second parking space assignment module assigns the unoccupied parking space closest to the current position of the navigation terminal as a new target parking space, and sends position information of the new target parking space to the navigation terminal.

According to the embodiments of the present invention, the auxiliary parking system may further comprise an instruction acquisition module configured to acquire an instruction from a user of the navigation terminal, the instruction indicating whether to accept the new target parking space; and a parking space update module configured to update the corresponding relation between the license plate number of the vehicle to be parked and the target parking space stored in the storage module when the new target parking space is accepted.

According to the embodiments of the present invention, the terminal position acquisition module may comprise a plurality of signal transmission modules arranged at a plurality of positions in the parking lot and configured to transmit position signals; and a position calculation module configured to acquire, in real time, strengths of the position signals transmitted from the signal transmission modules and received by the navigation terminal, and calculate relative position relation between the navigation terminal and each of the signal transmission modules according to the strengths of the position signals, so as to acquire the current position of the navigation terminal in the parking lot.

According to the embodiments of the present invention, the position calculation module may further be configured to send the obtained current position of the navigation terminal in the parking lot to said navigation terminal.

According to the embodiments of the present invention, the auxiliary parking system may further comprise a license plate number acquisition module, a judgment module, an alarm module and a status update module, which are provided corresponding to each parking space. The license plate number acquisition module is configured to detect whether a vehicle enters or leaves the corresponding parking space, acquire a license plate number of a vehicle when it is detected that the vehicle enters, and send a first control signal to the status update module when it is detected that a vehicle leaves. The judgment module is configured to judge whether the license plate number acquired by the license plate number acquisition module matches the parking space or not according to the corresponding relation between the license plate number of the vehicle to be parked and the target parking space stored in the storage module, and send a second control signal to the status update module if the license plate number matches the parking space, otherwise, send a third control signal to the alarm module. The status update module is configured to update the status information of the parking space stored in the storage module upon receipt of the first control signal or the second control signal. The alarm module is configured to generate an alarm signal upon receipt of the third control signal.

According to the embodiments of the present invention, the license plate number acquisition module may comprise a sensor and a license plate number acquisition unit. The sensor is configured to sense a distance between a vehicle and the sensor, send an instruction to the license plate number acquisition unit to acquire a license plate number when the distance decreases to reach a first distance, and send the first control signal to the status update module when the distance increases to reach a second distance.

According to another aspect of the present invention, there is provided a navigation terminal, comprising a target position acquisition module configured to acquire information including a map of a parking lot and a location of a target parking space in the parking lot; a positioning module configured to acquire position information including a current position in real time; and a processing module configured to acquire a route from the current position to a target position according to the current position, the target position and the map of the parking lot, wherein the target position includes the location of the target parking space in the parking lot or a location of an exit of the parking lot in the parking lot.

According to the embodiments of the present invention, the navigation terminal may further comprise a target parking space storage module configured to store the location of the target parking space in the parking lot.

According to the embodiments of the present invention, the navigation terminal may further comprise an instruction input module configured to acquire an instruction from a driver, the instruction indicating whether to accept an unoccupied parking space as a new target parking space when the target position includes the location of the target parking space in the parking lot and the unoccupied parking space is between the current position and the target parking space; an instruction sending module configured to send out the instruction of the driver; and a route update module configured to update a route from the current position to the target parking space according to the new target parking space when the new target parking space is accepted, and also updates the location of the target parking space in the parking lot stored in the target parking space storage module.

According to the embodiments of the present invention, the positioning module may comprise a signal receiving unit configured to receive position signals transmitted from a plurality of positions in the parking lot; a signal feedback unit configured to send out strengths of the position signals received from the plurality of positions; and a position information receiving unit configured to receive the position information including the current position in the parking lot determined based on the strengths of the position signals.

The auxiliary parking method and system according to the present invention can assign a target parking space to a vehicle to be parked, and send information including a map of a parking lot and a location of the target parking space to a navigation terminal corresponding to the vehicle to be parked. The navigation terminal can quickly find a route to the target parking space according to the obtained map of the parking lot and the obtained location of the target parking space. In addition, during movement towards the target parking space, the auxiliary parking system can acquire a current position of the navigation terminal of the vehicle in real time. When there is an unoccupied parking space between the current position of the navigation terminal and the target parking space, the unoccupied parking space closest to the navigation terminal can be assigned as a new target parking space, and a position thereof can be sent to the navigation terminal, so as to reduce time for parking. When picking up a vehicle, a driver can find the parked vehicle quickly under the guidance of the navigation terminal, thereby saving time for picking up the vehicle and prevent the driver from getting lost in the parking lot. Furthermore, the auxiliary parking system can send position signals to the navigation terminal from a plurality of positions in the parking lot, and locate a current position of the navigation terminal according to strengths of the position signals received by the navigation terminal from each of the positions, so that the navigation terminal can perform real-time positioning and navigation even in an underground parking lot.

### BRIEF DESCRIPTION OF THE DRAWINGS

The drawings constitute a part of the specification, and are used for providing further understanding of the present invention and for explaining the present invention together with following specific embodiments, but do not limit the present invention. In the drawings:

FIG. 1 is a schematic flow chart of an auxiliary parking method according to embodiments of the present invention;

FIG. 2 is a schematic flow chart of a navigation method according to the embodiments of the present invention;

FIG. 3 is a schematic block diagram of an auxiliary parking system according to the embodiments of the present invention;

FIG. 4 is a schematic block diagram of a part of an auxiliary parking system provided in each parking space according to the embodiments of the present invention;

FIG. 5 is a diagram schematically illustrating communication between a navigation terminal and the auxiliary parking system in a positioning process, according to the embodiments of the present invention; and

FIG. 6 is a schematic block diagram of a navigation terminal according to the embodiments of the present invention.

### REFERENCE NUMERALS

10—vehicle information acquisition module; 11—parking space information acquisition module; 12—first parking space assignment module; 12a—initial position acquisition unit; 12b—route information acquisition unit; 12c—parking space selection unit; 13—storage module; 14—parking space information sending module; 151—license plate number acquisition module; 152—judgment module; 153—alarm module; 154—status update module; 16—signal transmission module; 17—position calculation module; 181—terminal position acquisition module; 182—second parking space assignment module; 191—instruction acquisition module; 192—parking space update module; 20—target position acquisition module; 21—positioning module; 21a—signal receiving unit; 21b—signal feedback unit; 21c—position information receiving unit; 22—processing module; 22a—route information acquisition unit; 22b—optimal route acquisition unit; 23—instruction input module; 24—instruction transmission module; 25—route update module; 26—target parking space storage module.

### Detailed Description of the Embodiments

Specific implementations of the present invention will be further described in detail below with reference to the accompanying drawings. It should be understood that the specific implementations described here are only used for illustrating and explaining the present invention, rather than limiting the present invention.

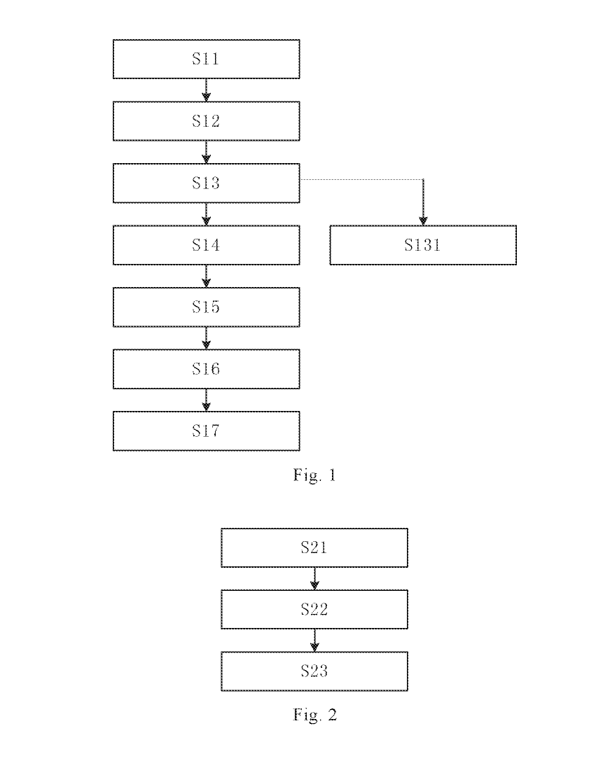

FIG. 1 is a schematic flow chart of an auxiliary parking method according to embodiments of the present invention.

As shown in FIG. 1, the auxiliary parking method according to the embodiments of the present invention comprises:

S11: acquiring identity information of a vehicle to be parked, the identity information including information of a navigation terminal corresponding to the vehicle;

S12: acquiring status information of each parking space in a parking lot, the status information including information indicating whether the parking space is occupied or not;

S13: when there is a unoccupied parking spaces in the parking lot, assigning a target parking space from all of the unoccupied parking space(s) to the vehicle to be parked; and

S14: sending information including a map of the parking lot and a location of the target parking space in the parking lot to the navigation terminal corresponding to the vehicle to be parked. It should be understood that “unoccupied parking space” in the present invention represents a parking space whose status is unoccupied.

According to the embodiments of the present invention, the navigation terminal may be a navigation device mounted on the vehicle or a handheld navigation device of a driver. In addition, the navigation terminal may be a navigation terminal assigned by a management staff of the parking lot to the vehicle to be parked after the identity information of the vehicle to be parked is acquired. The information of the navigation terminal may be hardware information (for example, MAC address) of the navigation terminal or other information capable of distinguishing the navigation terminal.

When the vehicle to be parked enters the parking lot, the target parking space is assigned to the vehicle to be parked, and the information including the map of the parking lot and the location of the target parking space in the parking lot is sent to the navigation terminal corresponding to the vehicle to be parked. The driver can navigate by using the navigation terminal, so as to reach the target parking space quickly, thereby significantly saving the time required for parking.

According to the embodiments of the present invention, the identity information of the vehicle to be parked may further include a license plate number of the vehicle to be parked. After the license plate number of the vehicle to be parked is acquired, the management staff of the parking lot may combine a navigation terminal with the license plate number and hand out the navigation terminal to the driver. In such case, the information of the navigation terminal may further include an identification number assigned to each navigation terminal in the parking lot. In addition, after the license plate number of the vehicle to be parked is acquired, the license plate number and the target parking space assigned to the vehicle to be parked can be stored in a correlative way (step S131 in FIG. 1), so as to facilitate management of the parking lot.

The target parking space assigned to the vehicle to be parked in step S13 may be any one of all of the unoccupied parking space(s). According to the embodiments of the present invention, in order to save the driver's parking time, step S13 may comprise steps of:

acquiring an initial position of the vehicle to be parked;

acquiring a route from the initial position to each unoccupied parking space and/or vehicle density on the route from the initial position to each unoccupied parking space; and

assigning the unoccupied parking space that the vehicle to be parked can reach in the shortest time as the target parking space according to the route from the initial position to each unoccupied parking space and/or the vehicle density on the route from the initial position to each unoccupied parking space.

As described above, the identity information of the vehicle to be parked may include the license plate number of the vehicle to be parked. To acquire the plate number, a device such as a camera may be provided at an entrance of the parking lot. In such case, the initial position of the vehicle to be parked is the position of the camera. In the case that the parking lot has a plurality of entrances, each entrance should be provided with a camera. The initial position of the vehicle to be parked can be determined according to the position of the camera which actually acquires the license plate number of the vehicle to be parked. In addition, “vehicle density” in the present invention refers to a ratio of the number of the vehicles on a route to the length of the route.

As shown in FIG. 1, the auxiliary parking method may further comprise a step of storing the status information of each parking space and corresponding relation between the license plate number of the vehicle to be parked and the target parking space (step S131).

The parking spaces whose statuses are unoccupied (that is, unoccupied parking spaces) can be determined according to the stored status of each parking space. When a vehicle enters or leaves a parking space, only the status information of said parking space needs to be updated, and there is no need to detect the statuses of all the parking spaces before each assignment of a target parking space for increasing efficiency of parking space assignment.

While the vehicle to be parked is moving from an entrance of the parking lot (the initial position of the vehicle) to the assigned target parking space, if there is an unoccupied parking space ahead (for example, a vehicle leaves a parking space) and the unoccupied parking space has not been assigned to another vehicle, the unoccupied parking space may be assigned to the vehicle to be parked, so as to further save parking time. As shown in FIG. 1, the auxiliary parking method according to the embodiments of the present invention may further comprise steps of:

S15: acquiring position information including a current position of the navigation terminal in real time;

S16: acquiring status information of each parking space positioned between the current position of the navigation terminal (that is, the current position of the vehicle to be parked) and the corresponding target parking space; and

S17: when there is an unassigned unoccupied parking space positioned between the current position of the navigation terminal and the corresponding target parking space, assigning the unoccupied parking space closest to the current position of the navigation terminal as a new target parking space, and sending position information of the new target parking space to the navigation terminal.

In the present description, “each parking space positioned between the current position of the navigation terminal and the corresponding target parking space” refers to each parking space that the vehicle to be parked corresponding to the navigation terminal has not pass yet on the route from the initial position thereof to the assigned target parking space. For example, if a target parking space assigned to a vehicle M1 to be parked is a parking space A, while the vehicle M1 to be parked is moving from an entrance of the parking lot (that is, the initial position of the vehicle M1 to be parked) to the parking space A, the vehicle M1 to be parked does not pass a parking space B on the route, and the parking space B is in the unoccupied state (for example, a vehicle M2 parked in the parking space B has left) and has not been assigned to another vehicle, the parking space B may be assigned, as a new target parking space, to the vehicle M1 to be parked in such case.

According to the embodiments of the present invention, the auxiliary parking method may further comprise a step of:

acquiring an instruction from a user (generally, the driver of the vehicle) of the navigation terminal, the instruction indicating whether to accept the new target parking space; and updating the stored corresponding relation between the license plate number of the vehicle to be parked and the target parking space when the new target parking space is accepted.

In the above example, when position information of the parking space B is sent to the navigation terminal and an inquiry is made to the driver about whether to accept the parking space B as the new target parking space, the driver can choose to accept or not. The stored corresponding relation between the license plate number of the vehicle to be parked and the target parking space may be updated according to the choice of the driver. That is, when the driver accepts the parking space B as the new target parking space, the stored corresponding relation between the license plate number of the vehicle to be parked and the parking space A can be updated to be corresponding relation between the license plate number of the vehicle to be parked and the parking space B.

A global positioning system (GPS) may be used to acquire the position information including the current position of the navigation terminal. However, when the parking lot is underground, the navigation terminal cannot receive a satellite positioning signal or the received satellite positioning signal is very weak, and therefore, such positioning method is not favorable for application in an underground parking lot. According to the embodiments of the present application, in order that the position information including the current position of the navigation terminal can be acquired in an area where a GPS signal cannot be received, such as an underground parking lot, step S15 may comprise steps of:

transmitting position signals from a plurality of positions in the parking lot;

acquiring, in real time, strengths of the position signals received by the navigation terminal from each of the positions; and

calculating relative position relations between the navigation terminal and the plurality of positions according to the strengths of each of the position signals received by the navigation terminal, so as to acquire the current position of the navigation terminal in the parking lot.

In addition, the position information including the current position of the navigation terminal may be sent to the navigation terminal. As a result, the navigation terminal can perform positioning and navigation without using GPS.

The plurality of positions in the parking lot, from which the position signals are transmitted, can be predetermined. The closer the navigation terminal comes to one of the plurality of positions, the larger the strength of the received position signal from said one position will be. Therefore, the relative position relation between the navigation terminal and each of the positions can be determined according to the strengths of the position signals which are transmitted from the plurality of positions and received by the navigation terminal, and thus the position of the navigation terminal in the parking lot can be determined. It should be understood that the more the positions from which the position signals are transmitted are, the more accurate the positioning of the current position of the navigation terminal will be.

According to the embodiments of the present invention, the auxiliary parking method may further comprise: detecting, for each parking space, whether a vehicle enters or leaves the parking space; when a vehicle enters a parking space, acquiring a license plate number of the vehicle which enters the parking space, judging whether the license plate number of the vehicle which enters the parking space matches the parking space or not according to the stored corresponding relation between the license plate number of the vehicle to be parked and the target parking space, updating the status information of the parking space if the license plate number of the vehicle which enters the parking space matches the parking space, otherwise, generating an alarm signal; and updating the status information of the parking space when a vehicle leaves the parking space.

According to the auxiliary parking method in the embodiments of the present invention, if the license plate number of the vehicle entering a parking space does not match the parking space, an alarm signal may be generated to warn the driver that the vehicle is parked in a wrong parking space, which ensures that each vehicle to be parked is parked in the corresponding target parking space, thereby facilitating management of the parking lot.

According to the embodiments of the present invention, the map of the parking lot may include the exit position of the parking lot, so that the driver can quickly find the exit of the parking lot by using the map received by the navigation terminal while leaving the parking lot.

According to the embodiments of the present invention, the auxiliary parking method may further comprise steps of: recording how long the vehicle to be parked has stayed in the parking lot, and calculating a corresponding parking fee.

FIG. 2 is a schematic flow chart of a navigation method according to the embodiments of the present invention

As shown in FIG. 2, the navigation method according to the embodiments of the present invention comprises:

S21: acquiring information including a map of a parking lot and a location of a target parking space in the parking lot, and storing the location of the target parking space in the parking lot;

S22: acquiring position information including a current position in real time; and

S23: acquiring a route from the current position to a target position according to the current position, the target position and the map of the parking lot, wherein the target position includes the location of the target parking space in the parking lot or a location of an exit of the parking lot in the parking lot.

The information including the map of the parking lot and the location of the target parking space in the parking lot can be acquired according to the auxiliary parking method of the present invention.

According to the embodiments of the present invention, in order to save time of a driver, step S23 may comprise:

acquiring each of routes from the current position to the target position and vehicle density on each of the routes from the current position to the target position; and

calculating a route along which the target position can be reached in the shortest time according to each of the routes from the current position to the target position and the vehicle density on each of the routes from the current position to the target position.

Specifically, the vehicle density on each of the routes may be compared with a preset value, and the shortest route among all of the routes on which the vehicle densities are smaller than the preset value is determined as the route along which the target position can be reached in the shortest time.

As described above, while a vehicle to be parked is moving from an entrance of the parking lot to the target parking space, if there is an unoccupied parking space that has not been assigned, the unoccupied parking space can be assigned as a new target parking space, a position of the new target parking space can be provided to the navigation terminal corresponding to the vehicle to be parked, and an inquiry is made to the driver about whether to accept the new target parking space. Correspondingly, the navigation method according to the embodiments of the present invention may further comprise:

when the target position includes the location of the target parking space in the parking lot and there is an unoccupied parking space between the current position and the target parking space, acquiring an instruction from a driver, the instruction indicating whether to accept the unoccupied parking space as a new target parking space;

when the new target parking space is accepted, updating a route from the current position to the target parking space according to the new target parking space, and updating the stored location of the target parking space in the parking lot; and

sending out the instruction of the driver.

As described above, in order that the position information including the current position can be acquired in an area where a GPS signal cannot be received, such as an underground parking lot, step S22 may comprise:

receiving position signals transmitted from a plurality of positions in the parking lot;

sending out strengths of the position signals received from the plurality of positions; and

receiving the position information including the current position in the parking lot determined based on the strengths of the position signals.

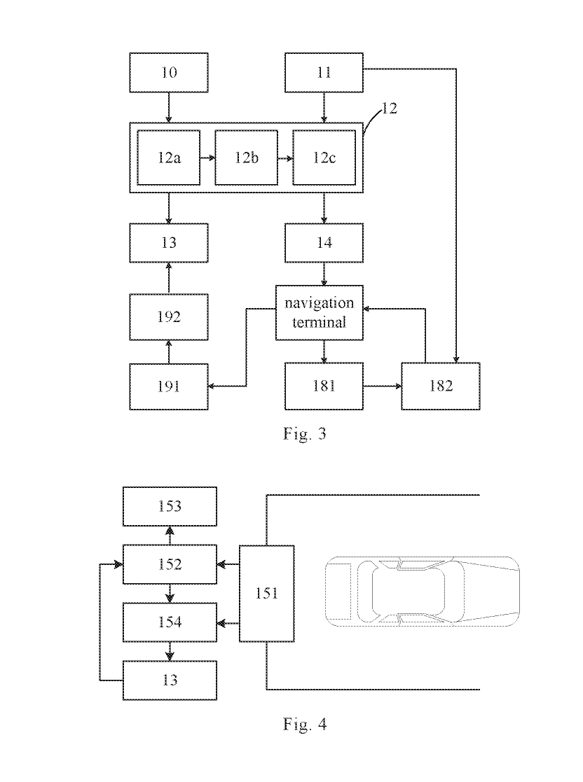

FIG. 3 is a schematic block diagram of an auxiliary parking system according to the embodiments of the present invention. The auxiliary parking system according to the embodiments of the present invention is used for implementing the auxiliary parking method according to the present invention. Characteristics and advantages stated in the description of the auxiliary parking method according to the present invention with reference to FIG. 1 will be omitted here.

With reference to FIG. 1 and FIG. 3, the auxiliary parking system according to the embodiments of the present invention comprises a vehicle information acquisition module 10, a parking space information acquisition module 11, a first parking space assignment module 12 and a parking space information sending module 14, which perform steps S11 to S14 of FIG. 1, respectively.

Specifically, the vehicle information acquisition module 10 is configured to acquire identity information of a vehicle to be parked, the identity information including information of a navigation terminal corresponding to the vehicle. The navigation terminal may be a handheld terminal which is owned by a driver and can perform navigation and communication. When the vehicle enters the parking lot, the vehicle information acquisition module 10 communicates with the navigation terminal of the driver to acquire the information of the navigation terminal. In addition, as described above, the navigation terminal may be a navigation terminal assigned by a management staff of the parking lot to the vehicle to the parked. In such case, a storage module 13 of the auxiliary parking lot may store information of each navigation terminal in advance, and the vehicle information acquisition module 10 can acquire the information of the navigation terminal directly from the storage module 13.

The parking space information acquisition module 11 is configured to acquire status information of each parking space in a parking lot, the status information including information which indicates whether the parking space is occupied or not. When there is an unoccupied parking space in the parking lot, the first parking space assignment module 12 assigns a target parking space from all of the unoccupied parking space(s) to the vehicle to be parked. In addition, the parking space information sending module 14 is configured to send information including a map of the parking lot and a location of the target parking space in the parking lot to the navigation terminal corresponding to the vehicle to be parked.

According to the embodiments of the present invention, the identity information of the vehicle to be parked may further include a license plate number of the vehicle to be parked. The vehicle information acquisition module 10 may firstly acquire an image of a license plate, and then perform an image processing on the license plate to identify the license plate number. According to the embodiments of the present invention, the auxiliary parking system may further comprise a controller connected with the vehicle information acquisition module 10. When the vehicle information acquisition module 10 acquires the license plate number, the controller can control a gate or a rail at an entrance of the parking lot to open.

As shown in FIG. 3, according to the embodiments of the present invention, the first parking space assignment module 12 may comprise an initial position acquisition unit 12a configured to acquire an initial position of the vehicle to be parked; a route information acquisition unit 12b configured to acquire a route from the initial position to each unoccupied parking space and/or vehicle density on the route from the initial position to each unoccupied parking space; and a parking space selection unit 12c configured to assign an unoccupied parking space that the vehicle to be parked can reach in the shortest time as the target parking space according to the route from the initial position to each unoccupied parking space and/or the vehicle density on the route from the initial position to each unoccupied parking space.

As shown in FIG. 3, the storage module 13 of the auxiliary parking system is configured to store the status information of each parking space and corresponding relation between a license plate number of the vehicle to be parked and the target parking space.

According to the embodiments of the present invention, the auxiliary parking system may further comprise a terminal position acquisition module 181 and a second parking space assignment module 182. The terminal position acquisition module 181 is configured to acquire position information including a current position of the navigation terminal in real time. The parking space information acquisition module 11 acquires status information of each parking space positioned between the current position of the navigation terminal and the corresponding target parking space, and when there is an unassigned unoccupied parking space positioned between the current position of the navigation terminal and the corresponding target parking space, the second parking space assignment module 182 assigns the unoccupied parking space closest to the current position of the navigation terminal as a new target parking space, and sends position information of the new target parking space to the navigation terminal.

According to the embodiments of the present invention, the auxiliary parking system may further comprise an instruction acquisition module 191 and a parking space update module 192. The instruction acquisition module 191 is configured to acquire an instruction from a user of the navigation terminal, the instruction indicating whether to accept the new target parking space. When the new target parking space is accepted, the parking space update module 192 updates the corresponding relation between the license plate number of the vehicle to be parked and the target parking space stored in the storage module 13.

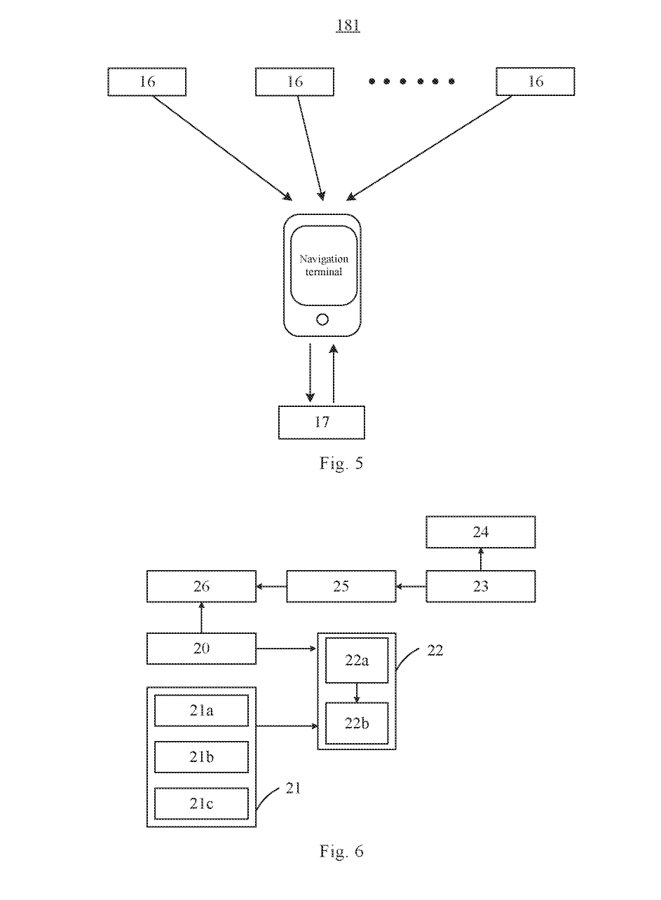

FIG. 5 is a diagram schematically illustrating communication between a navigation terminal and the auxiliary parking system in a positioning process according to the embodiments of the present invention.

With reference to FIG. 3 and FIG. 5, the terminal position acquisition module 181 of the auxiliary parking system may comprise a plurality of signal transmission modules 16 which are arranged at a plurality of positions in the parking lot and configured to transmit position signals; and a position calculation module 17 configured to acquire, in real time, strengths of the position signals transmitted from the signal transmission modules 16 and received by the navigation terminal, and calculate relative position relation between the navigation terminal and each of the signal transmission modules 16 according to the strengths of the position signals, so as to acquire the current position of the navigation terminal in the parking lot. In addition, the position calculation module 17 may further send the acquired current position of the navigation terminal in the parking lot to said navigation terminal.

The position signals transmitted from the plurality of signal transmission modules 16 may have the same signal strength, which facilitate calculation of the current position of the navigation terminal by the position calculation module 17. The signal transmission modules 16 may be WiFi hotspots capable of transmitting a WiFi signal, and the navigation terminal can be connected to each of the WiFi hotspots so as to receive the WiFi signal from each of the WiFi hotspots. The positions of the plurality of signal transmission modules 16 in the parking lot may be predetermined.

FIG. 4 is a schematic block diagram of a part of the auxiliary parking system provided in each parking space according to the embodiments of the present invention. The auxiliary parking system according to the embodiments of the present invention may further comprise a license plate number acquisition module 151, a judgment module 152, an alarm module 153 and a status update module 154, which are provided corresponding to each parking space.

The license plate number acquisition module 151 is configured to detect whether a vehicle enters or leaves the corresponding parking space, acquire a license plate number of a vehicle when it is detected that the vehicle enters, and send a first control signal to the status update module 154 when it is detected that a vehicle leaves. The judgment module 152 is configured to judge whether the license plate number acquired by the license plate number acquisition module 151 matches the parking space or not according to the corresponding relation between the license plate number of the vehicle to be parked and the target parking space stored in the storage module 3, send a second control signal to the status update module 154 if the license plate number matches the parking space, otherwise, send a third control signal to the alarm module 153. The status update module 154 is configured to update the status information of the parking space stored in the storage module 13 upon receipt of the first control signal or the second control signal. The alarm module 153 is configured to generate an alarm signal upon receipt of the third control signal so as to warn the driver that the vehicle is parked in a wrong parking space.

According to the embodiments of the present invention, the license plate number acquisition module 151 may comprise a sensor and a license plate number acquisition unit. The sensor is configured to sense a distance between a vehicle and the sensor, send an instruction to the license plate number acquisition unit to acquire a license plate number when the distance decreases to a first distance, and send the first control signal to the status update module 154 when the distance increases to a second distance. The first distance and the second distance may be set in advance by means of experiments. For example, when the sensor is arranged on a side of the parking space away from the entrance thereof, the first distance may be a half of the length of the parking space, and the second distance may be ¾ of the length of the parking space.

Although the sensor and the license plate number acquisition unit are described as separate units, the license plate number acquisition unit and the sensor may be integrated into one component.

The auxiliary parking system according to the embodiments of the present invention may further comprise a fee calculation module configured to record how long a vehicle has stayed in the parking lot, and calculate a corresponding parking fee.

FIG. 6 is a schematic block diagram of a navigation terminal according to the embodiments of the present invention. The navigation terminal according to the present invention is used for implementing the navigation method according to the present invention. Characteristics and advantages stated in description of the navigation method according to the present invention with reference to FIG. 2 will be omitted here.

With reference to FIG. 2 and FIG. 6, the navigation terminal according to the embodiments of the present invention comprises a target position acquisition module 20, a positioning module 21 and a processing module 22, which perform steps S21 to S23 of FIG. 2, respectively.

Specifically, the target position acquisition module 20 is configured to acquire information including a map of a parking lot and a location of a target parking space in the parking lot. The information including the map of the parking lot and the location of the target parking space in the parking lot can be sent by the auxiliary parking system according to the present invention, and received by the target position acquisition module 20. The positioning module 21 is configured to acquire position information including a current position in real time. The processing module 22 is configured to acquire a route from the current position to a target position according to the current position, the target position and the map of the parking lot. The target position may include the location of the target parking space in the parking lot or a location of an exit of the parking lot in the parking lot.

According to the embodiments of the present invention, the processing module 22 may comprises a route information acquisition unit 22a and an optimal route acquisition unit 22b. The route information acquisition unit 22a is configured to acquire each of routes from the current position to the target position and vehicle density on each of the routes from the current position to the target position. The optimal route acquisition unit 22b is configured to calculate a route along which the target position can be reached in the shortest time according to each of the routes from the current position to the target position and the vehicle density on each of the routes from the current position to the target position.

Specifically, the optimal route acquisition unit 22b comprises a first comparison subunit and a second comparison subunit. The first comparison subunit is configured to compare the vehicle density on each of the routes with a preset value. The second comparison subunit is configured to compare all of the routes on which the vehicle densities are smaller than the preset value with each other, so as to calculate the shortest route, which is determined as the route along which the target position can be reached in the shortest time.

The navigation terminal according to the embodiments of the present invention may further comprise a target parking space storage module 26 configured to store the location of the target parking space in the parking lot, so as to make it easy for the driver to pick up his vehicle when returning to the parking lot.

The navigation terminal according to the embodiments of the present invention may further comprise an instruction input module 23, an instruction sending module 24, and a route update module 25.

The instruction input module 23 is configured to acquire an instruction from a driver, the instruction indicating whether to accept an unoccupied parking space as a new target parking space when the target position includes the location of the target parking space in the parking lot and the unoccupied parking space is between the current position and the target parking space. The instruction sending module 24 is configured to send out the instruction of the driver. When the new target parking space is accepted, the route update module 25 updates a route from the current position to the target parking space according to the new target parking space, and updates the location of the target parking space in the parking lot stored in the target parking space storage module 26.

According to the embodiments of the present invention, the positioning module 21 may comprise a signal receiving unit 21a, a signal feedback unit 21b and a position information receiving unit 21c.

The signal receiving unit 21a is configured to receive position signals transmitted from a plurality of positions in the parking lot. The signal feedback unit 21b is configured to send out strengths of the position signals received from the plurality of positions. The position information receiving unit 21c is configured to receive the position information including the current position in the parking lot determined based on the strengths of the position signals.

It can be understood that the foregoing implementations are merely exemplary implementations adopted for describing the principle of the present invention, but the present invention is not limited thereto. Those of ordinary skill in the art can make various variations and improvements without departing from the spirit and essence of the present invention, and these variations and improvements shall be considered to fall into the protection scope of the present invention.

1. An auxiliary parking method, comprising steps of:
acquiring identity information of a vehicle to be parked, the identity information including information of a navigation terminal corresponding to the vehicle;
acquiring status information of each parking space in a parking lot, the status information including information indicating whether the parking space is occupied or not;
when there is at least one unoccupied parking space in the parking lot, assigning a target parking space from the at least one unoccupied parking space to the vehicle to be parked; and
sending information including a map of the parking lot and a location of the target parking space in the parking lot to the navigation terminal corresponding to the vehicle to be parked.

2. The auxiliary parking method according to claim 1, wherein the step of assigning a target parking space from the at least one unoccupied parking space to the vehicle to be parked comprises steps of:
acquiring an initial position of the vehicle to be parked;
acquiring a route from the initial position to each unoccupied parking space and/or vehicle density on the route from the initial position to each unoccupied parking space; and
assigning the unoccupied parking space that the vehicle to be parked can reach in the shortest time as the target parking space according to the route from the initial position to each unoccupied parking space and/or the vehicle density on the route from the initial position to each unoccupied parking space.

3. The auxiliary parking method according to claim 1, wherein the identity information further includes a license plate number.

4. The auxiliary parking method according to claim 3, further comprising a step of:
storing the status information of each parking space and corresponding relation between the license plate number of the vehicle to be parked and the target parking space.

5. The auxiliary parking method according to claim 4, further comprising steps of:
acquiring position information including a current position of the navigation terminal in real time;
acquiring status information of each parking space positioned between the current position of the navigation terminal and the corresponding target parking space; and
when there is an unassigned unoccupied parking space positioned between the current position of the navigation terminal and the corresponding target parking space, assigning the unoccupied parking space closest to the current position of the navigation terminal as a new target parking space, and sending position information of the new target parking space to the navigation terminal.

6. The auxiliary parking method according to claim 5, further comprising a step of:
acquiring an instruction from a user of the navigation terminal, the instruction indicating whether to accept the new target parking space; and
when the new target parking space is accepted, updating the stored corresponding relation between the license plate number of the vehicle to be parked and the target parking space.

7. The auxiliary parking method according to claim 5, wherein the step of acquiring position information including a current position of the navigation terminal in real time comprise steps of:
transmitting position signals from a plurality of positions in the parking lot;
acquiring, in real time, strengths of the position signals received by the navigation terminal from each of the positions; and
calculating relative position relations between the navigation terminal and the plurality of positions according to the strengths of each of the position signals received by the navigation terminal, so as to acquire the current position of the navigation terminal in the parking lot.

8. The auxiliary parking method according to claim 4, further comprising steps of:
detecting, for each parking space, whether a vehicle enters or leaves the parking space;
when a vehicle enters the parking space, acquiring a license plate number of the vehicle entering the parking space, judging whether the license plate number of the vehicle entering the parking space matches the parking space or not according to the stored corresponding relation between the license plate number of the vehicle to be parked and the target parking space, updating the status information of the parking space if the license plate number of the vehicle entering the parking space matches the parking space, otherwise, generating an alarm signal; and
when a vehicle leaves the parking space, updating the status information of the parking space.

9. A navigation method, comprising steps of:
acquiring information including a map of a parking lot and a location of a target parking space in the parking lot according to the auxiliary parking method of claim 1, and storing the location of the target parking space in the parking lot;
acquiring position information including a current position in real time; and
acquiring a route from the current position to a target position according to the current position, the target position and the map of the parking lot,
wherein the target position includes the location of the target parking space in the parking lot or a location of an exit of the parking lot in the parking lot.

10. The navigation method according to claim 9, wherein the step of acquiring a route from the current position to a target position comprises steps of:
acquiring each of routes from the current position to the target position and vehicle density on each of the routes from the current position to the target position; and
calculating a route along which the target position is reached in the shortest time according to each of the routes from the current position to the target position and the vehicle density on each of the routes from the current position to the target position,
wherein, the vehicle density on each of the routes is compared with a preset value, and the shortest route among all of the routes on which the vehicle densities are smaller than the preset value is determined as the route along which the target position is reached in the shortest time.

11. The navigation method according to claim 9, further comprising steps of:
when the target position includes the location of the target parking space in the parking lot and there is an unoccupied parking space positioned between the current position and the target parking space,
acquiring an instruction from a driver, the instruction indicating whether to accept the unoccupied parking space as a new target parking space;
when the new target parking space is accepted, updating a route from the current position to the target parking space according to the new target parking space, and updating the stored location of the target parking space in the parking lot; and
sending out the instruction of the driver.

12. The navigation method according to claim 9, wherein the step of acquiring position information including a current position in real time comprises steps of:
receiving position signals transmitted from a plurality of positions in the parking lot;
sending out strengths of the position signals received from the plurality of positions; and
receiving the position information including the current position in the parking lot determined based on the strengths of the position signals.

13. An auxiliary parking system, comprising:
a vehicle information acquisition module, configured to acquire identity information of a vehicle to be parked, the identity information including information of a navigation terminal corresponding to the vehicle;
a parking space information acquisition module, configured to acquire status information of each parking space in a parking lot, the status information including information indicating whether the parking space is occupied or not;
a first parking space assignment module, configured to assign a target parking space from at least one unoccupied parking space to the vehicle to be parked, when there is at least one unoccupied parking space in the parking lot; and
a parking space information sending module, configured to send information including a map of the parking lot and a location of the target parking space in the parking lot to the navigation terminal corresponding to the vehicle to be parked.

14. The auxiliary parking system according to claim 13, wherein the first parking space assignment module comprises:
an initial position acquisition unit, configured to acquire an initial position of the vehicle to be parked;
a route information acquisition unit, configured to acquire a route from the initial position to each unoccupied parking space and/or vehicle density on the route from the initial position to each unoccupied parking space; and
a parking space selection unit, configured to assign the unoccupied parking space that the vehicle to be parked is able to reach in the shortest time as the target parking space according to the route from the initial position to each unoccupied parking space and/or the vehicle density on the route from the initial position to each unoccupied parking space.

15. The auxiliary parking system according to claim 13, wherein the identity information further comprises a license plate number, and wherein
the auxiliary parking system further comprises a storage module configured to store the status information of each parking space and corresponding relation between the license plate number of the vehicle to be parked and the target parking space.

16. The auxiliary parking system according to claim 15, further comprising a terminal position acquisition module and a second parking space assignment module, wherein
the terminal position acquisition module is configured to acquire position information including a current position of the navigation terminal in real time,
the parking space information acquisition module acquires status information of each parking space positioned between the current position of the navigation terminal and the corresponding target parking space, and
when there is an unassigned unoccupied parking space positioned between the current position of the navigation terminal and the corresponding target parking space, the second parking space assignment module assigns the unoccupied parking space closest to the current position of the navigation terminal as a new target parking space, and sends position information of the new target parking space to the navigation terminal.

17. The auxiliary parking system according to claim 16, further comprising:
an instruction acquisition module, configured to acquire an instruction from a user of the navigation terminal, the instruction indicating whether to accept the new target parking space; and
a parking space update module, configured to update the corresponding relation between the license plate number of the vehicle to be parked and the target parking space stored in the storage module when the new target parking space is accepted.

18. The auxiliary parking system according to claim 16, wherein the terminal position acquisition module comprises:
a plurality of signal transmission modules arranged at a plurality of positions in the parking lot and configured to transmit position signals; and
a position calculation module, configured to acquire, in real time, strengths of the position signals transmitted from the signal transmission modules and received by the navigation terminal, and calculate relative position relation between the navigation terminal and each of the signal transmission modules according to the strengths of the position signals, so as to acquire the current position of the navigation terminal in the parking lot.

19. The auxiliary parking system according to claim 16, further comprising a license plate number acquisition module, a judgment module, an alarm module and a status update module, which are provided corresponding to each parking space, wherein
the license plate number acquisition module is configured to detect whether a vehicle enters or leaves the corresponding parking space, acquire a license plate number of a vehicle when it is detected that the vehicle enters, and send a first control signal to the status update module when it is detected that a vehicle leaves,
the judgment module is configured to judge whether the license plate number acquired by the license plate number acquisition module matches the parking space or not according to the corresponding relation between the license plate number of the vehicle to be parked and the target parking space stored in the storage module, and send a second control signal to the status update module if the license plate number matches the parking space, otherwise, send a third control signal to the alarm module,
the status update module is configured to update the status information of the parking space stored in the storage module upon receipt of the first control signal or the second control signal, and
the alarm module is configured to generate an alarm signal upon receipt of the third control signal.

20. The auxiliary parking system according to claim 19, wherein the license plate number acquisition module comprises a sensor and a license plate number acquisition unit, wherein
the sensor is configured to sense a distance between a vehicle and the sensor, send an instruction to the license plate number acquisition unit to acquire the license plate number when the distance decreases to a first distance, and send the first control signal to the status update module when the distance increases to a second distance.
